(19) United States
(12) Patent Application Publication
(10) Pub. No.: US 2022/0284354 A1
(43) Pub. Date: Sep. 8, 2022

(54) EVENT ADMINISTRATION SYSTEM

(71) Applicant: Amie ST. ARNAUD, Leduc (CA)

(72) Inventor: Amie ST. ARNAUD, Leduc (CA)

(21) Appl. No.: 17/189,739

(22) Filed: Mar. 2, 2021

(51) Int. Cl. G06Q 10/02; G06Q 20/18; G06K 9/62; G06K 15/02; G06K 9/00; H04N 7/18

(52) U.S. Cl. CPC G06Q 10/02; G06Q 20/18; G06K 9/6215; G06K 15/02; G06K 9/00664; H04N 7/18; G06K 9/00442

(57) ABSTRACT

An event administration system has a kiosk with a display and a user input. The kiosk has an event participant system and an administrator system in communication with each other. The administrator system allows an administrator to set sale parameters. The event participant system allows the event participant to make a purchasing decision based upon the set sale parameters of the administrator system. The set sale parameters are configured to allow a purchase of at least one sales item. A payment receiver for receiving payment from the event participant is provided. A scanning device is configured to receive information from the event participant. A ticket delivery system is provided for providing tickets to the event participant after a purchase has been made. The ticket delivery system provides a predetermined number of tickets based upon the set sale parameters and the purchasing decisions of the event participant.

### FIELD OF THE DISCLOSURE

The present application relates generally to an event administration system and more particularly relates to a cashless event administration system.

### BACKGROUND

This section provides background information to facilitate a better understanding of the various aspects of the invention. It should be understood that the statements in this section of this document are to be read in this light, and not as admissions of prior art.

The special events industry has grown tremendously beyond the simple County and state fairs. Very often, event organizers replace cash transactions with tickets or tokens. However, multiple long slow lines at special events to get tickets can cause problems, frustration, and loss of revenue. Additionally, most often it is the case that there are not enough sellers available to alleviate the lines. This can create a bottleneck effect that prevents potential customers from reaching lines for food, drink and other amenities at the event People may stop to socialize with a ticket seller and transactions to purchase tickets may be slow as those operating the distribution are not often trained or qualified to do this.

### BRIEF SUMMARY

There is provided an administration system that has a kiosk, a payment receiver, a scanning device and a ticket delivery system. The kiosk has a display and a user input. The kiosk has an event participant system and an administrator system in communication with each other. The administrator system allowing an administrator to set sale parameters. The administrator system is inaccessible to an event participant. The event participant system allows the event participant to make purchasing decisions based upon the set sale parameters of the administrator system. The set sale parameters are configured to allow a purchase of at least one sales item. The payment receiver receives payment from the event participant. The scanning device is configured to receive information from the event participant. The ticket delivery system at least one ticket for each of the at least one sales items purchased by the event participant. The ticket delivery system provides a predetermined number of tickets based upon the set sale parameters of the administrator system and the purchasing decisions of the event participant.

In one embodiment, a camera is positioned on, in or near the kiosk such that the camera creates a user image of the event participant.

In one embodiment, the set sale parameters of the administrator system includes at least one of a sales price, a maximum quantity per event participant and a minimum age threshold for purchasing.

In one embodiment, the scanning device is configured to scan the event participant's identification for the purpose of verifying an event participant's age.

In one embodiment, the scanning device is configured to scan a wristband that is supplied to the event participant who meets a prerequisite age.

In one embodiment, the kiosk will become unresponsive to the user inputs in the event that the event participant's age does not meet the minimum age threshold for purchasing.

In one embodiment, the kiosk will become unresponsive to the user inputs in the event that the event participant's identification and the user image do not meet a corresponding threshold of similarity. The corresponding threshold of similarity may be set in the administrator system.

In one embodiment, the ticket delivery system is a printer system.

In one embodiment, the ticket delivery system is a dispensing system to dispense at least one prefabricated ticket.

In one embodiment, the ticket delivery system is a signal delivered to a mobile device to provide the event participant with at least one virtual ticket.

In one embodiment, the kiosk has a printing apparatus for the printing of an event wristband.

In one embodiment, the kiosk has an event wristband delivery system for providing the event participant with a prefabricated event wristband.

In one embodiment, the at least one sales item may include food, beverages, event attractions and/or raffles such as 50/50 draws.

In one embodiment, the set sale parameters allow the event participant to provide a monetary donation.

In one embodiment, the set sale parameters allow the event participant to purchase gifts from a registry.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a schematic of the system.

FIG. 2 is a perspective view of a base computer.

FIG. 3 is a perspective view of an event control system.

FIG. 4 is a side elevation view, partially in section, of a kiosk.

### DETAILED DESCRIPTION OF THE PREFERRED EMBODIMENTS

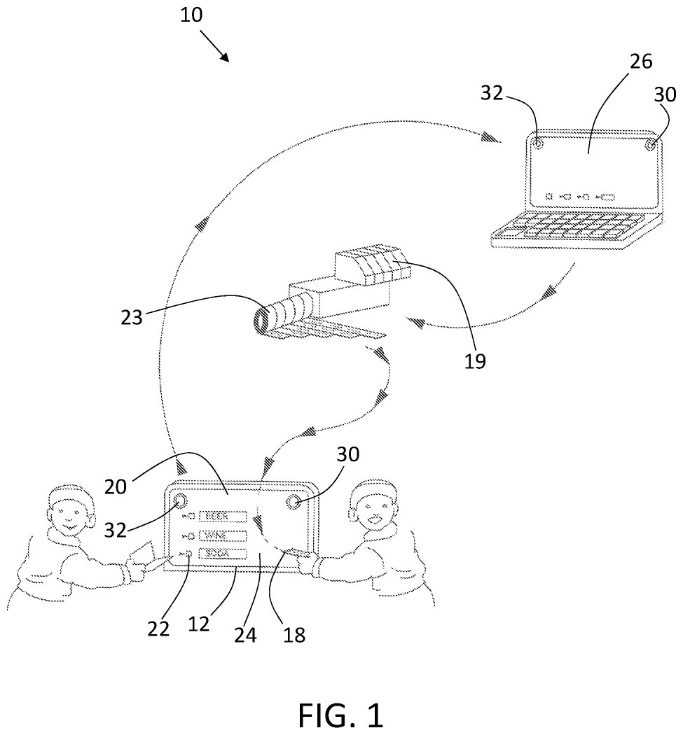

An event administration system, generally identified by reference numeral 10, will now be described with reference to FIG. 1 through FIG. 4.

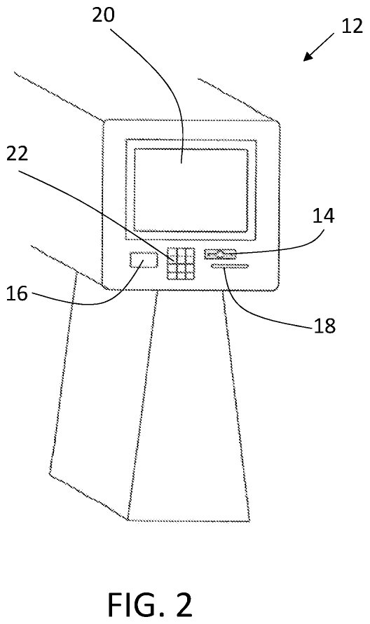

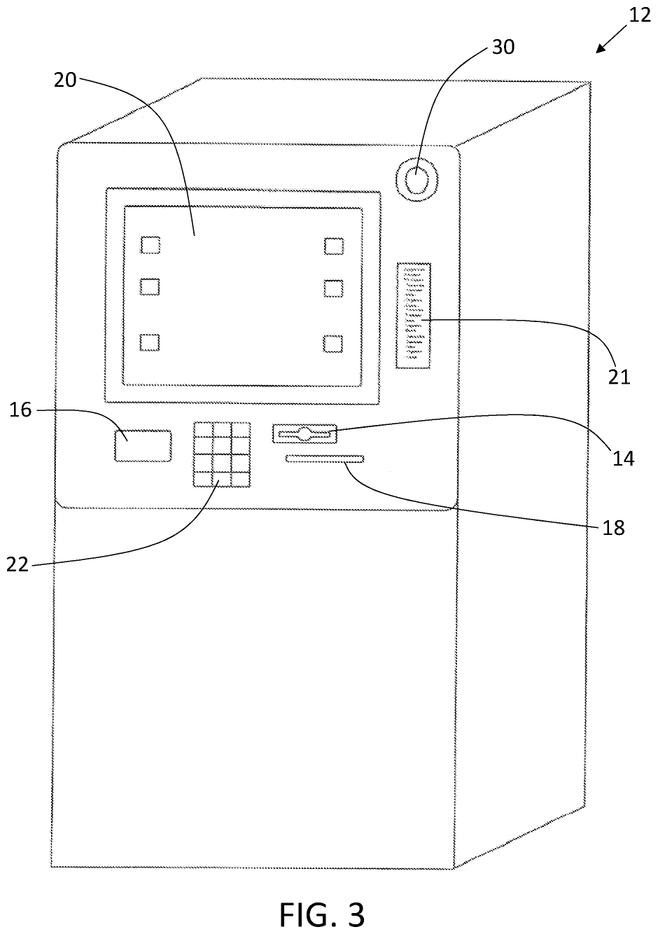

Referring to FIG. 2 and FIG. 3, event administration system 10 has a kiosk 12, a payment receiver 14, a scanning device 16 and a ticket delivery system 18. Kiosk 12 has a display 20 and a user input 22.

Kiosk 12 may be similar to an ATM device or may be more simplistic and be formed through a connection of computer CPU, monitor, user inputs 22 such as keyboard and mouse, and scanning and printing systems. Display 20 may be a touch screen such that user input 22 is integral with display 20. Display 20 provides event information to users of kiosk 12. Referring to FIG. 2, an instruction panel 21 may also be provided to provide instructions for use. Instruction panel 21 may be electronic or printed. Event administration system 10 may be used at a large number of different venues, including concerts, festivals, conferences, weddings, and the like.

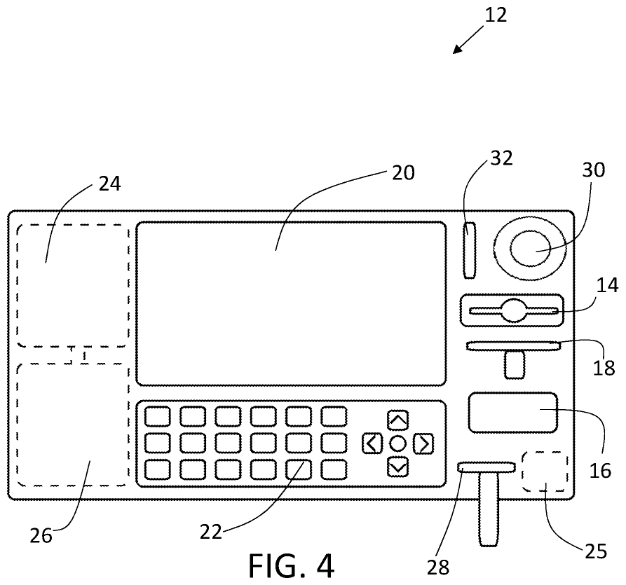

Referring to FIG. 4, kiosk 12 has an event participant system 24 and an administrator system 26 in communication with each other. Administrator system 26 allows an administrator to set sale parameters. Sale parameters may include sales prices, maximum quantities of items per event participant, minimum age thresholds for purchasing, and types of different items for sale. Sale items may include food, alcoholic beverages, non-alcoholic beverages, admissions to event attractions, monetary donations, raffle tickets, other gambling items, and any other common sales item known to a person skilled in the art. Kiosk 12 may also allow the event participant to purchase gifts from a registry. To facilitate this feature, kiosk 12 may have internet compatibility such as a modem 25, wi-fi connection or wired internet connection. To prevent tampering to the set sale parameters, administrator system 26 is inaccessible to an event participant. This may be achievable through the use of a username and password, limiting access through the use of a lock box, special command codes, separating administrator system 26 physically from event participant system 24 or any other method known to a person skilled in the art. The event participant system 24 allows an event participant to make a purchasing decision based upon the set sale parameters of administrator system 26. The event participant views sale offerings and prices on display 20. The event participant utilizes user inputs 22 to choose the sales items for purchase.

Once event participant has chosen their sales items, payment can be made using payment receiver 14. Payment receiver 14 may accept cash, credit cards, debit cards, electronic payments, electronic prepayments or any other type of payment known to a person skilled in the art. The type of payment accepted by payment receiver 14 may be set by an administrator. For example, an administrator may choose to not accept cash so as to avoid issues with money in kiosk 12, potential thefts and other risks associated with cash purchases. Scanning device 16 is provided to receive information from event participant. Scanning device 16 may be used to scan identification such as government issued identification, identification bands given to event participants to identify them as event participants, bar codes, images, mobile devices or any other scannable device known to a person skilled in the art. Administrator system 26 can be set up to accept specific scannable items based upon the items available for purchase. For example, when alcohol beverages are available at the event, scanning items may be used to scan government issued identification to confirm the age of the event participant. Information received by scanning device 16 may include the age of the event participant, an image of the event participant, information related to prepurchased tickets or any other suitable information. An example of how scanning device 16 operates can include the ability of the event participant to scan a bar code readable invitation. The event participant would then receive tickets from ticket delivery system 18 or have the option to purchase tickets using kiosk 12. Kiosk 12 may be set up such that kiosk 12 becomes unresponsive to user inputs 22 in the event that the event participant's age does not meet the minimum age threshold for purchasing. This can be determined by the information received from scanning device 16. This is most beneficial where products such as alcohol beverages can be purchased.

Ticket delivery system 18 provides tickets to the event participant based upon the sales items purchased by the event participant. The number of tickets that are provided are dependent upon the purchasing decisions of the event participant and set sale parameters of administrator system 26. Ticket delivery system 18 may be a printing system such as a printer 19 that connects to a computer to print tickets 23. Ticket delivery system 18 may also be a dispensing system that dispenses prefabricated tickets. A person of skill will understand that prefabricated tickets such as those purchasable in large rolls may be placed within kiosk 12 and dispensed by systems known to persons skilled in the art. Ticket delivery system 18 may also deliver a signal to a mobile device to provide the event participant with virtual tickets. A person of skill will understand that the type of ticket delivery system 18 that is used will be dependent upon the needs of system operators. It may also be possible for ticket delivery system 18 to include more than one of the abovementioned systems such that multiple different types of tickets may be provided. In addition to ticket delivery system 18, kiosk 12 may have a printing apparatus used for printing event wristbands. An event wristband delivery system 28 may also be provided for providing event participants with prefabricated event wristbands.

Event administration system 10 has a camera 30 that is positioned in, on, or near kiosk 12 to record the event participant using the kiosk 12 to create a user image. The user image may be used to keep a record of event participants and provide additional security. It may also be used to assist in determining the eligibility of the event participant to purchase items. Kiosk 12 may become unresponsive to user inputs 22 in the event that the event participant's identification and the user image do not meet a corresponding threshold of similarity. The corresponding threshold of similarity is set in administrator system 26. A person of skill will understand that different facial recognition software may be used, however administrator system 26 may be set to confirm more common details such as hair color, eye color and height in determining the corresponding threshold of similarity.

In the event that an event participant has difficulty using kiosk 12, kiosk 12 may have a microphone 32 that allows for communication from kiosk 12 to a predetermined location set by an administrator. When the administrator is contacted for assistance, they may be able to assist either remotely or in person.

Event administration system 10 allows for the possibility of a cashless event. This can increase security at an event and prevent situations where an event participant loses their cash. To provide further security, a mobile computing application can be provided in conjunction with kiosk 12 to allow for the prepurchase of tickets or syncing information over one or more events.

In the embodiment shown in FIG. 1, event participant system 24 and an administrator system 26 are separated from each other physically but in wireless or wired communication. An event participant utilizes kiosk 12 that has touch screen capabilities as user input 22 and the information is sent to administrator system 26. Printing 19 prints appropriate information on tickets 23 based on the event participants choices and ticket delivery system 18 provides tickets to event participants.

Any use herein of any terms describing an interaction between elements is not meant to limit the interaction to direct interaction between the subject elements and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above but should be given the broadest interpretation consistent with the description as a whole.

What is claimed is:

1. An event administration system comprising:
a kiosk having a display and a user input, the kiosk having an event participant system and an administrator system in communication with each other, the administrator system allowing an administrator to set sale parameters, the administrator system being inaccessible to an event participant, the event participant system allowing the event participant to make a purchasing decisions based upon the set sale parameters of the administrator system, the set sale parameters being configured to allow a purchase of at least one sales item;
a payment receiver for receiving payment from the event participant;
a scanning device configured to receive information from the event participant;
a ticket delivery system for providing at least one ticket for each of the at least one sales items purchased by the event participant, the ticket delivery system providing a predetermined number of tickets based upon the set sale parameters of the administrator system and the purchasing decisions of the event participant.

2. The event administration system of claim 1 further comprising a camera positioned such that the camera creates a user image of the event participant using the kiosk.

3. The event administration system of claim 1 wherein the set sale parameters of the administrator system include at least one of a sales price, a maximum quantity per event participant and a minimum age threshold for purchasing.

4. The event administration system of claim 3 wherein the scanning device is configured to scan the event participant's identification for the purpose of verifying an event participant's age.

5. The event administration system of claim 4 wherein the kiosk will become unresponsive to the user inputs in the event the event participant's age does not meet the minimum age threshold for purchasing.

6. The event administration system of claim 2 wherein the scanning device is configured to scan the event participant's identification for the purpose of verifying an event participants age.

7. The event administration system of claim 6 wherein the kiosk will become unresponsive to the user inputs in the event the event participant's identification and the user image do not meet a corresponding threshold of similarity, the corresponding threshold of similarity being set in the administrator system.

8. The event administration system of claim 1 wherein the ticket delivery system is a printer system.

9. The event administration system of claim 1 wherein the ticket delivery system is a dispensing system to dispense at least one prefabricated ticket.

10. The event administration system of claim 1 wherein the ticket delivery system is a signal delivered to a mobile device to provide the event participant with at least one virtual ticket.

11. The event administration system of claim 1 wherein the kiosk further comprises a printing apparatus for the printing of an event wristband.

12. The event administration system of claim 1 wherein the kiosk further comprises an event wristband delivery system for providing the event participant with a prefabricated event wristband.

13. The event administration system of claim 1 wherein the at least one sales item includes food.

14. The event administration system of claim 1 wherein the at least one sales item includes beverages.

15. The event administration system of claim 1 wherein the at least one sales item includes event attractions.

16. The event administration system of claim 1 wherein the set sale parameters allow the event participant to provide a monetary donation.

17. The event administration system of claim 1 wherein the at least one sales item includes raffles.

18. The event administration system of claim 1 wherein the set sale parameters allow the event participant to purchase gifts from a registry.

19. The event administration system of claim 1 wherein the scanning device is configured to scan an event wristband for the purpose of verifying the event age.
